(19) United States
(12) Patent Application Publication
(10) Pub. No.: US 2013/0081520 A1
(43) Pub. Date: Apr. 4, 2013

(54) CONNECTOR TOOL

(71) Applicants: Joachim I. GREK, Katrineholm (SE); Owen R. Barthelmes, Putnam Valley, NY (US); Michael A. Hoyack, Sandy Hook, CT (US); Hardik Parikh, Danbury, CT (US); Ken Capozzi, Naugatuck, CT (US)

(72) Inventors: Joachim I. GREK, Katrineholm (SE); Owen R. Barthelmes, Putnam Valley, NY (US); Michael A. Hoyack, Sandy Hook, CT (US); Hardik Parikh, Danbury, CT (US); Ken Capozzi, Naugatuck, CT (US)

(73) Assignee: Amphenol Corporation, Wallingford, CT (US)

(21) Appl. No.: 13/250,371

(22) Filed: Sep. 30, 2011

(51) Int. Cl. B25B 13/50; B25B 15/02

(52) U.S. Cl. 81/119; 81/52

(57) ABSTRACT

A tool for a connector that comprises a main body that has first and second opposite ends. The first end is configured to receive a torque device and has a substantially circular cross-sectional shape. The second end is configured to grasp a connector and has a substantially semi-circular cross-sectional shape, thereby defining an open side of the second end. The second end has at least one engagement member for engaging the connector.

### Related Application

This application may relate to commonly owned U.S. patent application Ser. No. ______ to Connector Tool, filed concurrently herewith, the subject matter of which is hereby incorporated by reference.

### FIELD OF THE INVENTION

The present invention relates to a tool for facilitating the installation and removal of a connector. More specifically, the tool is designed to grasp a connector while maintaining a low profile, thereby allowing use of the tool in high density applications.

### BACKGROUND OF THE INVENTION

Electrical connectors, particularly radio frequency (RF) connectors, provide couplings between electrical elements and/or devices. Many different types of electrical connectors exist and have been used to provide removable electrical connections between electronic elements and devices. In higher power applications, such as wireless base stations, larger connectors are used and must be tightened sufficiently to achieve proper RF performance. Common connector types include 7/16 or Type N connectors.

Conventional RF coupling connector components facilitate attachment of coaxial electrical cables to electronic elements or devices. Typical RF coupling connector components include a jack mounted to an electronic device or element and a plug connected to a cable. High power connector components, such as 7/16 and Type N utilize a threaded coupling to maintain the proper interface mating force for optimal electrical performance The required coupling torque typically requires a crescent wrench and minimum torque value.

Often, multiple coupling connector components are positioned in close proximity to one another on electronic elements or devices, both vertically and horizontally, to provide a high density of connectors. However, there is often insufficient space for manual manipulation of the connectors to install and remove them especially if a conventional tool, such as a crescent wrench is used.

Therefore, a need exists for a connector tool that can be used in high density applications to both install and remove connector components.

### SUMMARY OF THE INVENTION

Accordingly, the present invention provides a tool for a connector that comprises a main body that has first and second opposite ends. The first end is configured to receive a torque device and has a substantially circular cross-sectional shape. The second end is configured to grasp a connector and has a substantially semi-circular cross-sectional shape, thereby defining an open side of the second end. The second end has at least one engagement member for engaging the connector.

The present invention may also provide a tool for a connector that comprises a unitary one-piece main body that has first and second opposite ends. The first end has a substantially circular cross-sectional shape and has a socket. The second end is configured to grasp a connector and has a substantially semi-circular cross-sectional shape, thereby defining an open side of the second end. The second end has a plurality a spaced teeth extending therefrom for engaging corresponding slots in the connector. In a preferred embodiment, a torque device is received in the socket of the first end of the main body.

Other objects, advantages and salient features of the invention will become apparent from the following detailed description, which, taken in conjunction with the annexed drawings, discloses a preferred embodiment of the present invention.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a perspective view of a tool according to an exemplary embodiment of the present invention;

FIG. 2 is a partial perspective view of an end of the tool illustrated in FIG. 1, showing the tool engaged with a connector;

FIG. 3 is a perspective view of a high density of connectors, showing the tool illustrated in FIG. 1, grasping one of the connectors;

FIG. 4 is a perspective view of the tool illustrated in FIG. 1, showing a torque device coupled to the tool; and

FIG. 5 is a perspective view of a high density of connectors, showing the tool with the torque device illustrated in FIG. 4, grasping one of the connectors.

### DETAILED DESCRIPTION OF THE INVENTION

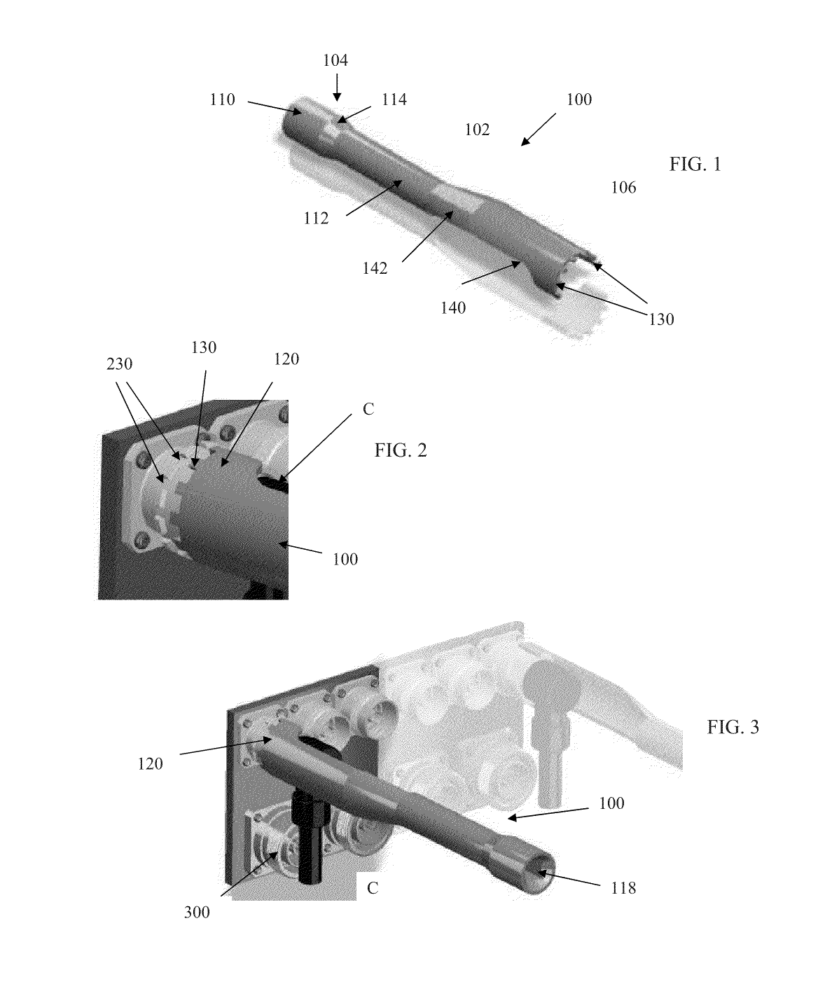

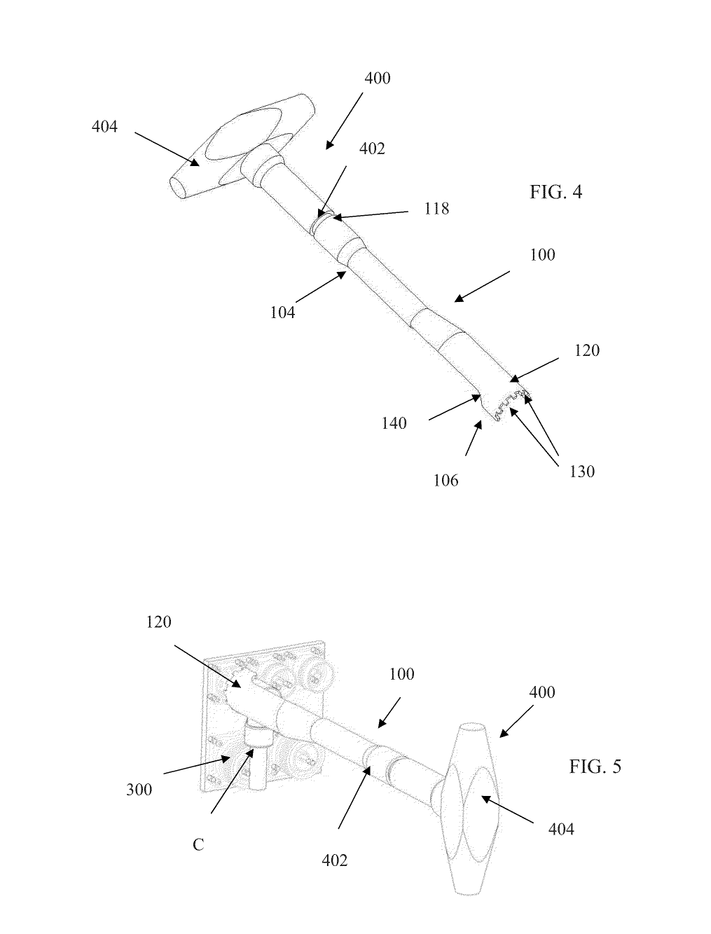

Referring to FIGS. 1-5, a connector tool 100 according to an exemplary embodiment of the present invention generally includes a main body 102 that has one end 104 for grasping a connector C (FIG. 2), such as a BNC connector or the like, and another opposite end 106 adapted to couple to a torque device 400 (FIGS. 4 and 5). The torque device 400 allows an operator to manually apply torque to the tool 100 which in turn rotates the connector C for coupling the connector to a mating connector or panel 300 (FIG. 3). The main body 102 is preferably a unitary one-piece member that may be made of any rigid material, such as metal or plastic like high strength steel with a clear corrosion-resistant zinc coating.

The first end 104 of the tool 100 includes a socket section 110 and a reduced diameter section 112. The sections 110 and 112 have a substantially circular shape in cross-section. A tapered step 114 is defined between the socket section 110 and the reduced diameter section 112. The socket section 110 includes a socket 118 configured to mate with an end 402 of the torque device 400. Alternative to the socket 118 may include a wrench flat, a torx drive, or a hex drive, and the like. The torque device 400 may be any conventional torque device. The torque device 400 preferably includes a handle 404 to facilitate rotation of the tool 100.

The second end 106 of the tool 100 has a grasping portion 120 that defines an open side 122 for receiving the connector C, as seen in FIGS. 2, 3 and 5. The cross-sectional shape of the grasping portion 120 is substantially semi-circular, as best seen in FIG. 1. The grasping portion 120 includes a plurality of engagement members 130 for detachably engaging the connector C such that when the tool is rotated, the connector C also rotates. In an exemplary embodiment, the engagement members 130 are preferably uniformly spaced teeth that extend from the end of the grasping portion 120. Alternative, the engagement members 130 may longitudinal grooves or ribs, multi-point or star shaped teeth, or cylindrical pins and the like. The teeth 130 may engage corresponding grooves or slots 230, for example, of the connector C. The corresponding grooves or slots 230 may be any structure that corresponds to the engagement members 130. When the teeth 130 are received in the grooves 230 of the connector C, the tool second end 106 partially encircles a portion of the connector C such that the tool 100 and connector C are positively engaged. Although a plurality of teeth 130 are preferred, any number of teeth may be used along with any number of corresponding grooves on the connector. The grasping portion 120 may include a relief area 140 that provides a low profile for the tool and thus less interference with adjacent connectors when operating the tool 100 in a high density of connectors. Between the grasping portion 120 of the second end 106 and the reduced diameter section 112 of the first end 104 may be a tapered area 142.

To detachably engage the tool 100 with the connector C, the operator aligns the teeth 130 with the corresponding grooves on the connector. The operator then slides the tool 100 longitudinally over the connector until that the teeth 130 are received in the grooves of the connector C. The operator then applies torque to the handle 404 of the torque device 400 and the torque is transmitted from the handle 404 through the first end 104 of the tool to the grasping portion 120 at the tool's second end 106 that at least partially encircles the connector. That torque rotates the tool 100 and the connector C together to either install or remove the connector C. To disengage the tool 100 from the connector C, the operator longitudinally slides the tool away from the connector C until the teeth 130 clear the grooves 230 of the connector.

While a particular embodiment has been chosen to illustrate the invention, it will be understood by those skilled in the art that various changes and modifications can be made therein without departing from the scope of the invention as defined in the appended claims. For example, any known mating engagement members may be used to couple the tool 100 and the connector C and are not limited to teeth and grooves. Also, the engagement members may be reversed such that the teeth 130 are provided on the connector C and the grooves 230 are provided on the grasping portion 120 of the tool.

What is claimed is:

1. A tool for a connector, comprising:
a main body having first and second opposite ends,
said first end being configured to receive a torque device and having a substantially circular cross-sectional shape, and
said second end being configured to grasp a connector and having a substantially semi-circular cross-sectional shape, thereby defining an open side of said second end, and said second end having at least one engagement member for engaging the connector.

2. A tool according to claim 1, wherein
said main body is a unitary one-piece member.

3. A tool according to claim 1, wherein
said first end includes a socket for receiving the torque device.

4. A tool according to claim 1, wherein
said second end includes a plurality of engagement members extending therefrom configured to engage the connector.

5. A tool according to claim 4, wherein
said engagement members are teeth adapted to engage corresponding slots in the connector.

6. A tool according to claim 1, wherein
said second end includes a relief portion between said at least one engagement member and said first end.

7. A tool for a connector, comprising:
a unitary one-piece main body having first and second opposite ends, said first end having a substantially circular cross-sectional shape and having a socket, and said second end being configured to grasp a connector and having a substantially semi-circular cross-sectional shape, thereby defining an open side of said second end, and said second end having a plurality a spaced teeth extending therefrom for engaging corresponding slots in the connector.

8. A tool according to claim 7, further comprising
a torque device received in said socket of said first end of said main body.

9. A tool according to claim 8, wherein
said torque device is a wrench.

10. A tool according to claim 8, wherein
said torque device includes a handle.

11. A tool according to claim 7, wherein
a relief portion is disposed in said second end of said main body between said plurality of engagement teeth and said first end.

12. A tool according to claim 7, wherein
said plurality teeth are substantially identical and uniformly spaced.
